(19) United States
(12) Patent Application Publication
(10) Pub. No.: US 2018/0081966 A1
(43) Pub. Date: Mar. 22, 2018

(54) TEXT VISUALIZATION SYSTEM, TEXT VISUALIZATION METHOD, AND RECORDING MEDIUM

(71) Applicant: NEC CORPORATION, Tokyo (JP)

(72) Inventors: Takashi ONISHI, Tokyo (JP); Kosuke YAMAMOTO, Tokyo (JP); Susumu AKAMINE, Tokyo (JP); Takao KAWAI, Tokyo (JP); Masaaki TSUCHIDA, Tokyo (JP)

(73) Assignee: NEC CORPORATION, Tokyo (JP)

(21) Appl. No.: 15/558,354

(22) PCT Filed: Mar. 18, 2015
(86) PCT No.: PCT/JP2015/001511

§ 371 Date: Sep. 14, 2017

(51) Int. Cl. G06F 17/30

(52) U.S. Cl. CPC G06F 17/30716; G06F 17/30707

(57) ABSTRACT

A text visualization system which allows a user to efficiently ascertain a result of clustering of texts is provided. A clustering system (1) includes a representative text display unit (51), a reception unit (55), and an element text display unit (52). The clustering system (1) is accessibly connected to a storage that stores a plurality of texts and information indicating a representative text and an element text that entails the representative text among the plurality of texts. The representative text display unit (51) displays a plurality of representative texts. The reception unit (55) receives a designation of a specific representative text among the plurality of representative texts. The element text display unit (52) extracts, in response to receiving the designation of the specific representative text, an element text that entails the designated specific representative text from the plurality of texts, and displays the extracted element text.

### TECHNICAL FIELD

The present invention relates to a text visualization system, a text visualization method, and a recording medium, and in particular, to a text visualization system, a text visualization method, and a recording medium for clustering of texts.

### BACKGROUND ART

Reading and organization/analysis of a large number of texts by a person need a large amount of time and labor. Therefore, a technique of supporting text analysis work of a person in such a way that the person can analyze a text group to be analyzed within a limited time is desired.

As a technique for ascertaining an outline of a text group that is a large number of texts, for example, a clustering technique of classifying a large number of texts into a plurality of groups, based on words included in the texts, is known.

As a clustering technique for texts, there is, for example, a technique described in NPL 1. The technique disclosed in NPL 1 groups, based on frequencies of words (keywords) appearing in texts, the words semantically and thereby classifies a text group into a plurality of groups.

In general, in each text to be clustered, a plurality of viewpoints may be mixed. Therefore, in keyword-based clustering, a viewpoint of each cluster may become unclear due to an oversight of a viewpoint, classification of texts having different viewpoints into the same cluster, or the like. In this case, a user is forced, in order to clarify a viewpoint, to perform cumbersome work such that texts of a plurality of clusters are confirmed and the texts are reclassified.

As a related technique, NPL 2 discloses an entailment clustering technique of extracting an entailment relation between texts and classifying texts having an entailment relation into the same group. PTL 1 discloses a technique of generating an entailment graph representing an entailment relation, based on an entailment relation between texts. PTL 2 discloses a technique of extracting utterances from a set of dialogue texts and extracting utterances having an entailment relation as an utterance cluster. PTL 3 discloses a technique of generating groups each having a contribution relation between documents and generating a group net representing entailment relations among groups.

### CITATION LIST

### Patent Literature

[PTL 1] Japanese Patent No. 5494999

[PTL 2] Japanese Patent Application Laid-open Publication No. 2013-190991

[PTL 3] Japanese Patent Application Laid-open Publication No. H09-152968

### Non Patent Literature

[NPL 1] “Technology Marketing by Visualization of Patent Information-Utilization of Text Mining and Network Analysis-”, [online], NRI Cyber Patent, Ltd., [retrieved on Feb. 17, 2015], the Internet <URL:https://www.jpo.go.jp/shiryou/s_sonota/pdf/kigyou/nri.pdf>

[NPL 2] “NEC Technology Automatically Groups Vast Amounts of Text Data According to Meaning”, [online], NEC Corporation, [retrieved on Feb. 17, 2015], the Internet <URL:http://jpn.nec.com/press/201411/20141118_02.html>

### SUMMARY OF INVENTION

### Technical Problem

As described above, in a keyword-based clustering technique, there has been a technical problem that user work for clarifying a viewpoint is needed and therefore a user load is large.

An object of the present invention is to provide a text visualization system, a text visualization method, and a recording medium, being capable of solving the above-described technical problem and allowing a user to efficiently ascertain a result of clustering of texts.

### Solution to Problem

A text visualization system according to an exemplary aspect of the invention, accessibly connected to storage means that stores a plurality of texts and information indicating a representative text and an element text that entails the representative text among the plurality of texts, includes: first display means for displaying a plurality of representative texts; reception means for receiving a designation of a specific representative text among the plurality of representative texts; and second display means for extracting, in response to receiving the designation of the specific representative text, an element text that entails the designated specific representative text from the plurality of texts, and displaying the extracted element text, wherein a relation between a representative text and an element text that entails the representative text is a relation that the representative text is true when the element text is true.

A text visualization method according to an exemplary aspect of the invention, for a plurality of texts among which a representative text and an element text that entails the representative text are set, includes: displaying a plurality of representative texts; receiving a designation of a specific representative text among the plurality of representative texts; and extracting, in response to receiving the designation of the specific representative text, an element text that entails the designated specific representative text from the plurality of texts, and displaying the extracted element text, wherein a relation between a representative text and an element text that entails the representative text is a relation that the representative text is true when the element text is true.

A computer readable storage medium according to an exemplary aspect of the invention records thereon a program causing a computer to perform a text visualization method, for a plurality of texts among which a representative text and an element text that entails the representative text are set, including: displaying a plurality of representative texts; receiving a designation of a specific representative text among the plurality of representative texts; and extracting, in response to receiving the designation of the specific representative text, an element text that entails the designated specific representative text from the plurality of texts, and displaying the extracted element text, wherein a relation between a representative text and an element text that entails the representative text is a relation that the representative text is true when the element text is true.

### Advantageous Effects of Invention

A technical advantageous effect of the present invention is to allow a user to efficiently ascertain a result of clustering of texts.

### BRIEF DESCRIPTION OF DRAWINGS

FIG. 1 is a block diagram illustrating a basic configuration of a first example embodiment of the present invention.

FIG. 2 is a block diagram illustrating a configuration of a clustering system 1 in the first example embodiment of the present invention.

FIG. 3 is a block diagram illustrating a configuration of the clustering system 1 realized by a computer in the first example embodiment of the present invention.

FIG. 4 is a flowchart illustrating an operation of the clustering system 1 in the first example embodiment of the present invention.

FIG. 5 is a diagram illustrating an example of text data to be clustered in the first example embodiment of the present invention.

FIG. 6 is a diagram illustrating an example of an extraction result of entailment relations in the first example embodiment of the present invention.

FIG. 7 is a diagram illustrating an example of a clustering result in the first example embodiment of the present invention.

FIG. 8 is a diagram illustrating an example of a clustering screen 80 (before designating a display condition) in the first example embodiment of the present invention.

FIG. 9 is a diagram illustrating an example of the clustering screen 80 (upon designating a representative text) in the first example embodiment of the present invention.

FIG. 10 is a diagram illustrating an example of the clustering screen 80 (upon designating a plurality of representative texts) in the first example embodiment of the present invention.

FIG. 11 is a diagram illustrating an example of the clustering screen 80 (upon designating an attribute value) in the first example embodiment of the present invention.

FIG. 12 is a diagram illustrating an example of the clustering screen 80 (upon designating an attribute value and an acquisition period) in the first example embodiment of the present invention.

FIG. 13 is a diagram illustrating an example of the clustering screen 80 (upon designating an attribute value, an acquisition period, and a representative text) in the first example embodiment of the present invention.

FIG. 14 is a block diagram illustrating a configuration of a clustering system 1 in a second example embodiment of the present invention.

FIG. 15 is a diagram illustrating an example of an analysis screen 90 (upon displaying a spreadsheet) in the second example embodiment of the present invention.

FIG. 16 is a diagram illustrating an example of the analysis screen 90 (upon displaying adjusted standardized residuals) in the second example embodiment of the present invention.

FIG. 17 is a diagram illustrating an example of relations among representative texts and element texts in the example embodiments of the present invention.

### DESCRIPTION OF EMBODIMENTS

First, entailment clustering that is a clustering technique for texts used in example embodiments of the present invention will be described. In the entailment clustering, as described in NPL 2, clustering is executed based on an entailment relation that is a relation of meanings between texts.

In the example embodiments of the present invention, the entailment relation is defined as follows in the same manner as in PTL 1. It is defined that, in the case where a content of a second text is true when a content of a first text is true, the first text entails the second text. Further, it may also be defined that, in the case where a content of a second text is read from a content of a first text, the first text entails the second text. By using entailment clustering, viewpoints included in texts to be analyzed can be extracted without omission, together with a representative text representing an outline of a cluster, and commonly entailed by texts in the cluster.

In order to facilitate understanding of an entailment relation, specific examples are described.

### SPECIFIC EXAMPLE 1

First text: President Obama is living in the White House.
Second text: President Obama is living in America.

In this case, a content of the second text is true when a content of the first text is true, and therefore it can be said that the first text entails the second text.

### SPECIFIC EXAMPLE 2

First text: Prime Minister Tsuyoshi Inukai was assassinated by naval officers.
Second Text: Prime Minister Tsuyoshi Inukai died.

In this case, a content of the second text is true when a content of the first text is true, and therefore it can be said that the first text entails the second text.

A “representative text” and an “element text” are defined here. When entailment clustering is executed for a set of texts, a representative text and an element text are determined. A relation between a representative text and an element text is a relation that a content of the representative text is true when a content of the element text is true. In other words, a relation between a representative text and an element text is a relation that the element text entails the representative text.

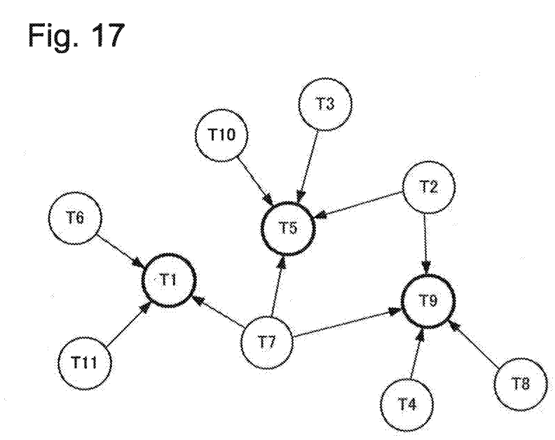

FIG. 17 is a diagram illustrating an example of relations among representative texts and element texts in the example embodiments of the present invention. In order to facilitate understanding of a representative text and an element text, description will be made using FIG. 17. FIG. 17 illustrates a situation in which entailment clustering has been executed for eleven texts from T1 to T11. A circular symbol in FIG. 17 indicates one text. An arrow in FIG. 17 indicates that a text at a source of the arrow entails a text at a destination of the arrow. In FIG. 17, texts T6, T7, and T11 entail a text T1. In the same manner, texts T2, T3, T7, and T10 entail a text T5, and texts T2, T4, T7, and T8 entail a text T9. At that time, the texts T6, T7, and T11 are element texts of a representative text T1. In the same manner, the texts T2, T3, T7, and T10 are element texts of a representative text T5. In the same manner, the texts T2, T4, T7, and T8 are element texts of a representative text T9.

A representative text itself may be handled as an element text. For example, the texts T1, T6, T7, and T11 may be element texts of the representative text T1.

### First Example Embodiment

Next, a first example embodiment of the present invention will be described.

First, a configuration of the first example embodiment of the present invention will be described.

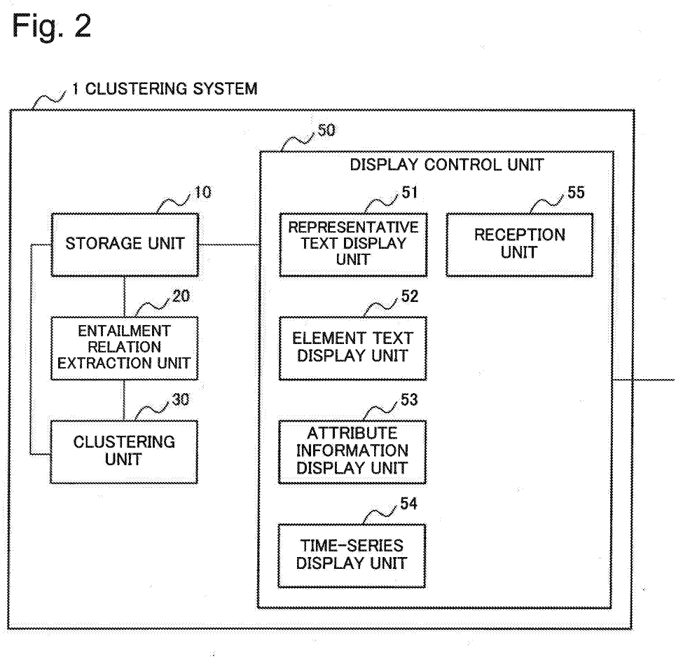

FIG. 2 is a block diagram illustrating a configuration of a clustering system 1 in the first example embodiment of the present invention.

Referring to FIG. 2, the clustering system 1 in the first example embodiment of the present invention includes a storage unit 10, an entailment relation extraction unit 20, a clustering unit 30, and a display control unit 50. The clustering system 1 is one example embodiment of the text visualization system of the present invention.

The storage unit 10 stores text data indicating texts to be clustered and a result of clustering (a clustering result) between the texts.

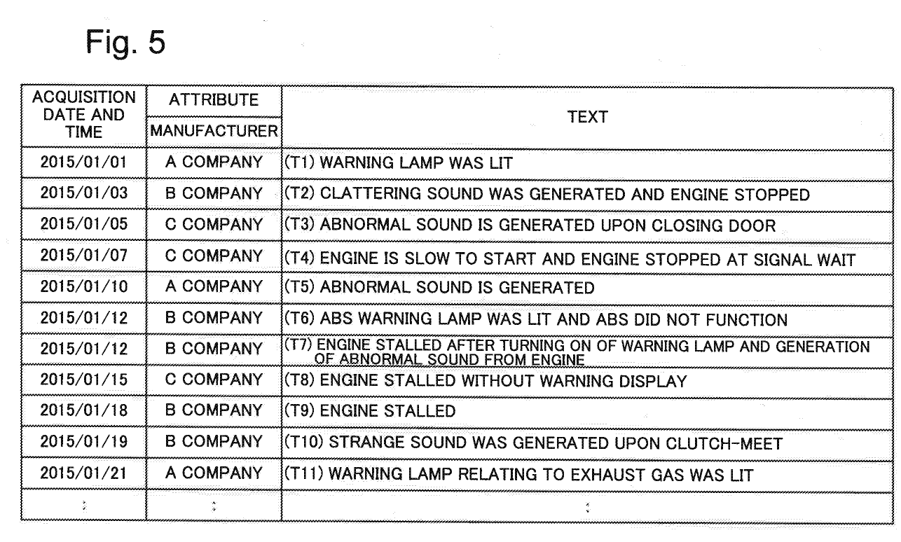

FIG. 5 is a diagram illustrating an example of text data in the first example embodiment of the present invention. The example of FIG. 5 is an example in which texts to be clustered are natural language texts relating to “phenomena of failures” in failure reports of automobiles. In the example of FIG. 5, text data includes an acquisition date and time of a text, an attribute (manufacturer), and a text. A symbol in a parenthesis preceding a text indicates an identifier of the text.

A text to be clustered is extracted, for example, from a document (a failure report or the like). In this case, a text is extracted, for example, by acquiring description for a designated category (phenomenon) in a document described for each of a plurality of categories (a phenomenon of a failure, a cause, a measure, and the like) in accordance with a predetermined format. Further, the text may be extracted by identifying a description portion relating to a category to be clustered from a document written in a free format. Further, the text may be extracted, for example, from a call log generated by voice-recognizing conversations in a call center or the like.

The entailment relation extraction unit 20 extracts an entailment relation between texts to be clustered.

The clustering unit 30 executes entailment clustering for texts to be clustered based on the extracted entailment relation and generates a plurality of clusters in which a representative text and element texts each entailing the representative text are set.

The display control unit 50 generates a clustering screen 80 for displaying, based on a clustering result, a representative text and an element text to be displayed (hereinafter, described also as a target element text), and displays (outputs) the generated screen to the user or the like.

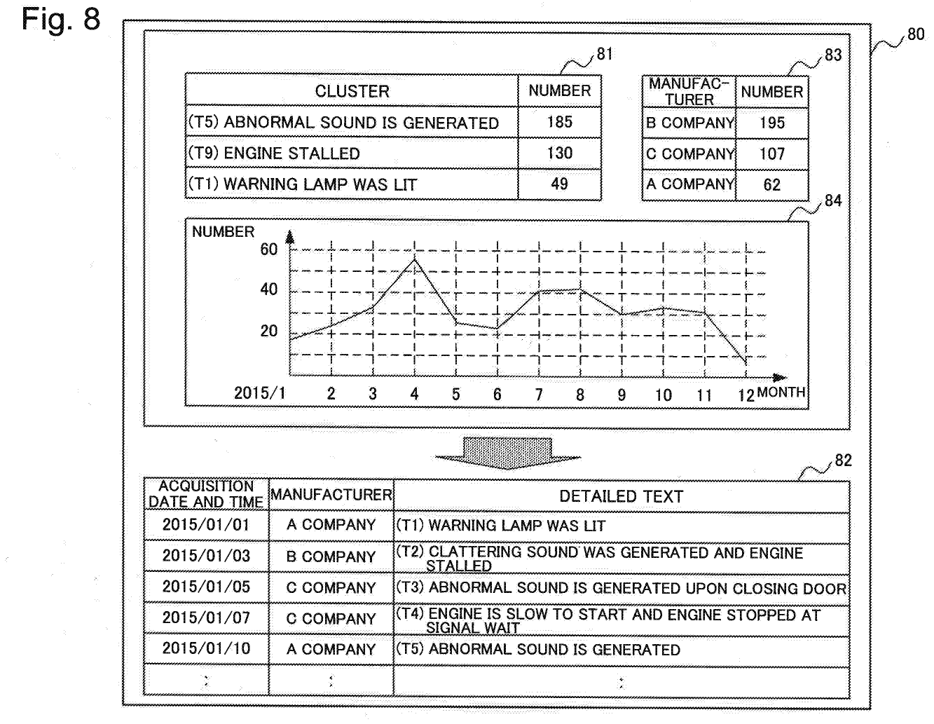

FIG. 8 is a diagram illustrating an example of the clustering screen 80 (before designating a display condition) in the first example embodiment of the present invention.

The clustering screen 80 includes a representative text display area 81, an element text display area 82, an attribute information display area 83, and a time-series display area 84.

In a “cluster” column of the representative text display area 81, a representative text of each cluster is displayed. Further, in a “number” column, the number of element texts that entail each representative text (element texts belonging to a cluster of each representative text), among target element texts, is displayed. A representative text of the representative text display area 81 may be displayed in a descending (or an ascending) order of the number of element texts indicated in the “number” column.

In a “detailed text” column of the element text display area 82, a target element text is displayed, for example, in a time-series order, in association with an acquisition date and time, and an attribute value.

In a “number” column of the attribute information display area 83, the number of element texts including each attribute value indicated in a “manufacturer” column, among target element texts, is displayed. An attribute value of the attribute information display area 83 may be displayed in a descending (or an ascending) order of the number of element texts indicated in the “number” column.

In the time-series display area 84, a graph indicating the number of target element texts for each acquisition date and time (time-series of the number of target element texts) is displayed.

The display control unit 50 includes a representative text display unit 51 (or a first display unit), an element text display unit 52 (or a second display unit), an attribute information display unit 53 (or a third display unit), a time-series display unit 54 (or a fourth display unit), and a reception unit 55.

The representative text display unit 51 displays a representative text of each cluster in the representative text display area 81.

The reception unit 55 receives a designation of a condition (hereinafter, described also as a display condition) for a target element text from the user or the like in the clustering screen 80. In the example embodiments of the present invention, as a display condition, a combination (an AND condition) of one or more of a representative text, an attribute value, and an acquisition period is designated. In this case, the target element text is, of all the texts to be clustered, an element text that entails a representative text specified by a display condition (belongs to a cluster of the representative text), includes an attribute value specified by the display condition, and has an acquisition date and time within an acquisition period specified by the display condition. As a display condition, instead of an AND condition, an OR condition may be designated.

The element text display unit 52 extracts (narrows down) a target element text in accordance with a display condition from texts to be clustered, and displays the extracted text in the element text display area 82.

The attribute information display unit 53 displays the number of target element texts for each attribute value in the attribute information display area 83.

The time-series display unit 54 displays a graph indicating the number of target element texts for each acquisition date and time (time-series of the number of target element texts) in the time-series display area 84.

The clustering system 1 may be a computer that includes a CPU (Central Processing Unit) and a storage medium storing a program and operates by control based on the program.

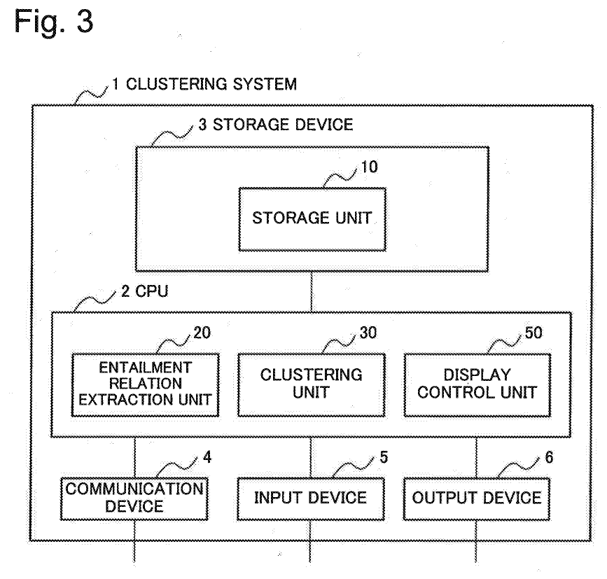

FIG. 3 is a block diagram illustrating a configuration of the clustering system 1 realized by a computer in the first example embodiment of the present invention.

The clustering system 1 includes a CPU 2, a storage device 3 (a storage medium) such as a hard disk, a memory, and the like, a communication device 4 that communicates with another apparatus and the like, an input device 5 such as a mouse, a keyboard, and the like, and an output device 6 such as a display and the like.

The CPU 2 executes computer programs for realizing functions of the entailment relation extraction unit 20, the clustering unit 30, and the display control unit 50. The storage device 3 stores data of the storage unit 10. The output device 6 outputs the clustering screen 80 to the user or the like. The input device 5 receives a designation of a display condition from the user or the like. Further, the communication device 4 may output the clustering screen 80 to another apparatus and receive a designation of a display condition from another apparatus.

Further, the components of the clustering system 1 illustrated in FIG. 2 may be independent logic circuits. Further, the components of the clustering system 1 illustrated in FIG. 2 may be arranged distributively in a plurality of physical apparatuses connected via a wired or wireless channel.

Next, the operation of the first example embodiment of the present invention will be described.

Herein, it is assumed that text data as in FIG. 5 is stored on the storage unit 10.

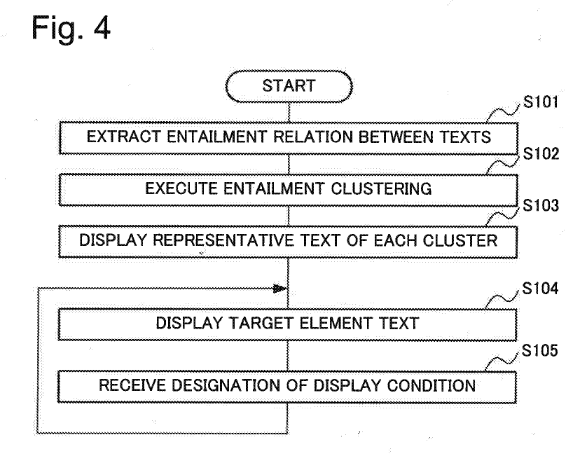

FIG. 4 is a flowchart illustrating the operation of the clustering system 1 in the first example embodiment of the present invention.

First, the entailment relation extraction unit 20 extracts an entailment relation between texts to be clustered stored on the storage unit 10 (step S101).

Herein, the entailment relation extraction unit 20 extracts an entailment relation between texts by executing, for example, the same determination process as in PTL 1. In this case, the entailment relation extraction unit 20 compares content words included in texts, calculates a coverage ratio, and thereby determines the presence or absence of an entailment relation. The entailment relation extraction unit 20 may determine an entailment relation between texts by determination process different from that of PTL 1, as long as an entailment relation between texts is extracted.

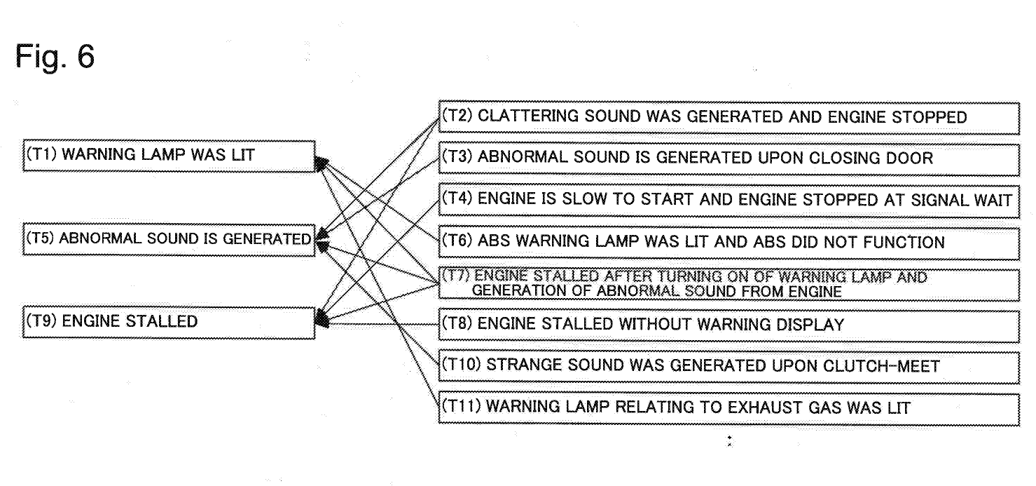

FIG. 6 is a diagram illustrating an example of an extraction result of entailment relations in the first example embodiment of the present invention. In FIG. 6, it is indicated that a text at a source of an arrow entails a text at a destination of the arrow. In the example of FIG. 6, texts T6, T7, T11, . . . entail a text T1. In the same manner, texts T2, T3, T7, T10, . . . entail a text T5, and texts T2, T4, T7, T8, . . . entail a text T9.

For example, the entailment relation extraction unit 20 extracts entailment relations as illustrated in FIG. 6 with respect to the texts of FIG. 5.

The clustering unit 30 executes entailment clustering for texts to be clustered stored on the storage unit 10 (step S102).

Herein, the clustering unit 30 executes entailment clustering, for example, based on the entailment relation extracted by the entailment relation extraction unit 20 in the same manner as the technique of NPL 2. As a result of clustering, when a text entails a plurality of representative texts, the text is set as an element text of a plurality of clusters. In the example embodiments of the present invention, a text set as a representative text of a certain cluster is also set as an element text that entails the representative text of the cluster. The clustering unit 30 stores, on the storage unit 10, a clustering result that associates an identifier of a representative text of each cluster with an identifier of an element text of the cluster.

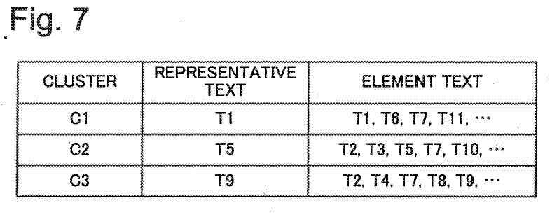

FIG. 7 is a diagram illustrating an example of a clustering result in the first example embodiment of the present invention. In the example of FIG. 7, texts T1, T5, and T9 are set as representative texts of clusters C1, C2, and C3, respectively. Further, the text T1 and texts T6, T7, T11, . . . that entail the text T1 are set as element texts of the cluster C1. In the same manner, the text T5 and texts that entail the text T5 are set as element texts of the cluster C2, and the text T9 and texts that entail the text T9 are set as element texts of the cluster C3.

For example, the clustering unit 30 generates a clustering result as in FIG. 7 based on the entailment relations of FIG. 6.

The clustering unit 30 may further integrate, based on an overlap degree of element texts between different clusters, the different clusters into one cluster.

Next, the representative text display unit 51 of the display control unit 50 displays a representative text of each cluster in the representative text display area 81 of the clustering screen 80 based on the clustering result stored on the storage unit 10 (step S103).

For example, the representative text display unit 51 displays representative texts T5, T9, and T1 in the representative text display area 81 as in FIG. 8 based on the clustering result of FIG. 7.

The element text display unit 52 displays, in the element text display area 82, a target element text extracted from texts to be clustered in accordance with a display condition (step S104). At the beginning, a display condition is not designated, and therefore, for example, all the texts to be clustered are used as target element texts. Further, at the same time, the representative text display unit 51, the attribute information display unit 53, and the time-series display unit 54 update the numbers of element texts of the representative text display area 81, the attribute information display area 83, and the time-series display area 84, respectively, according to target element texts.

For example, the element text display unit 52 displays, as in FIG. 8, all the texts T1, T2, . . . to be clustered in the element text display area 82. Further, the representative text display unit 51 displays, as in FIG. 8, the number of element texts that entail each representative text among all the texts to be clustered in the representative text display area 81. The attribute information display unit 53 displays, as in FIG. 8, the number of element texts including each attribute value among all the texts to be clustered in the attribute information display area 83. The time-series display unit 54 displays, as in FIG. 8, a graph indicating the number for each acquisition date and time with respect to all the texts to be clustered in the time-series display area 84.

The user or the like refers to the representative text display area 81 of FIG. 8 and thereby can ascertain overall failures and a failure (“abnormal sound is generated”) having a large number of occurrences at an outline level. Further, the user or the like refers to the attribute information display area 83 and thereby can ascertain an attribute (“B company”) having a large number of occurrences of failures. Further, the user refers to the time-series display area 84 and thereby can ascertain a period (“2015/3 to 5” and the like) having a large number of occurrences of failures.

Next, the reception unit 55 receives, in the clustering screen 80, a designation of a display condition (a representative text, an attribute value, and an acquisition period) (step S105).

Herein, the reception unit 55 receives, for example, by mouse-click detection of a representative text displayed in the representative text display area 81, a designation of the representative text. Further, the reception unit 55 receives, by mouse-click detection of an attribute value displayed in the attribute information display area 83, a designation of the attribute value. Further, the reception unit 55 receives, by mouse-drag detection of a range of specific acquisition dates and times of a time series displayed on the time-series display unit 54, a designation of an acquisition period.

Thereafter, the processing from step S104 is repeated, and every time a display condition is received, the clustering screen 80 is updated in accordance with the display condition.

Using several examples of the display condition, the operation of steps S104 and S105 will be described below.

<A Case Where a Representative Text has been Designated as a Display Condition>

A case where the user or the like confirms details for a failure “abnormal sound is generated” of an outline level having the largest number of occurrences in the representative text display area 81 of FIG. 8 will be considered. For example, the reception unit 55 receives a designation of a representative text T5 “abnormal sound is generated” from the user or the like as a display condition in the representative text display area 81 of FIG. 8.

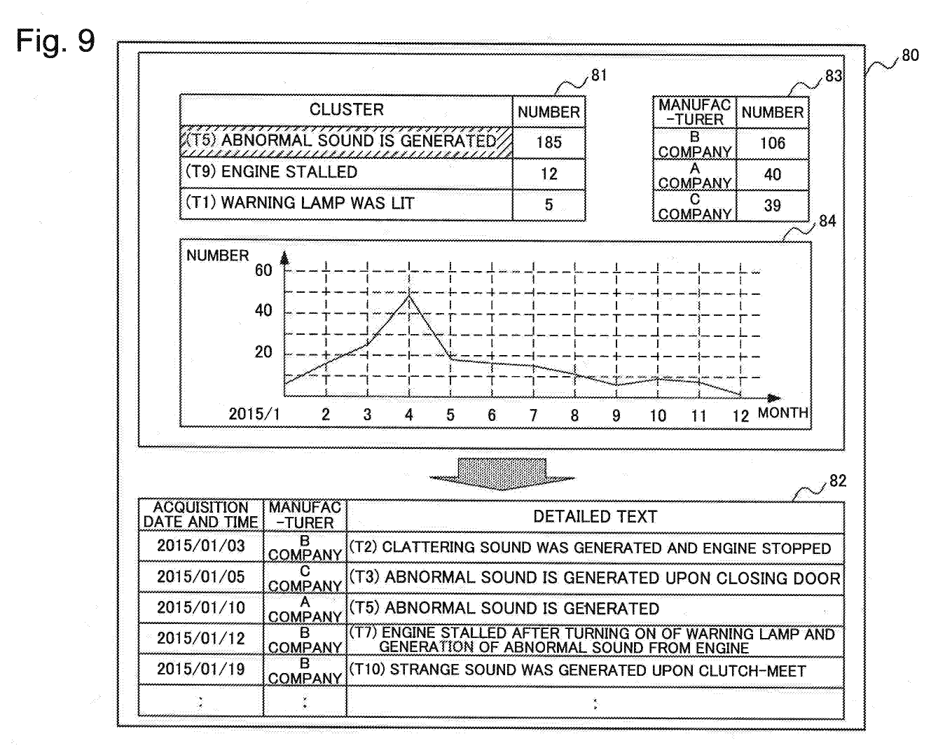

FIG. 9 is a diagram illustrating an example of the clustering screen 80 (upon designating a representative text) in the first example embodiment of the present invention.

The element text display unit 52 displays, as in FIG. 9, element texts T2, T3, T5, T7, T10, . . . that are target element texts entailing the representative text T5 (element texts belonging to the cluster C2) in the element text display area 82.

The representative text display unit 51 updates, as in FIG. 9, the number of element texts that entail each representative text of the representative text display area 81 with the number of element texts that entail each representative text and the representative text T5. The attribute information display unit 53 updates, as in FIG. 9, the attribute information display area 83 by using the number of element texts including each attribute value among element texts that entail the representative text T5. The time-series display unit 54 updates, as in FIG. 9, the time-series display area 84 by using a time series of the element texts that entail the representative text T5.

The user or the like refers to the element text display area 82 of FIG. 9 and thereby can ascertain details of a failure (“abnormal sound is generated”) of an outline level.

<A Case Where a Plurality of Representative Texts have been Designated as a Display Condition>

A case where the user or the like confirms details for a failure belonging to both failures “abnormal sound is generated” and “the engine stalled” of an outline level in the representative text display area 81 of FIG. 9 will be considered. For example, the reception unit 55 further receives, from the user or the like, addition of a designation of the representative text T9 “the engine stalled” as a display condition in the representative text display area 81 of FIG. 9.

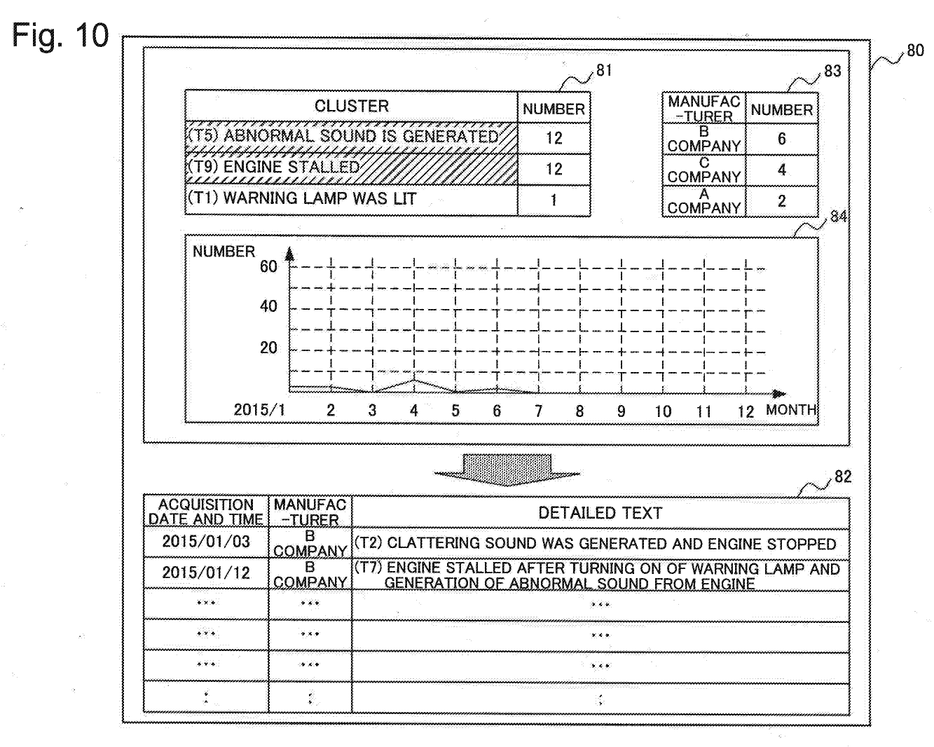

FIG. 10 is a diagram illustrating an example of the clustering screen 80 (upon designating a plurality of representative texts) in the first example embodiment of the present invention.

The element text display unit 52 displays, as in FIG. 10, element texts T2, T7, . . . that are target element texts entailing both representative texts T5 and T9 (belonging to the clusters C2 and C3) in the element text display area 82.

The user or the like refers to the element text display area 82 of FIG. 10 and thereby can ascertain details of a failure belonging to both of a plurality of failures “abnormal sound is generated” and “the engine stalled” of an outline level.

The element text display unit 52 may display, as a target element text, an element text that entails at least one of the representative text T5 and T9, instead of an element text that entails both representative texts T5 and T9.

<A Case Where an Attribute Value has been Designated as a Display Condition>

A case where the user or the like confirms a failure of an outline level for a manufacturer “B company” having the largest number of occurrences of failures in the attribute information display area 83 of FIG. 8 will be considered. For example, the reception unit 55 receives a designation of an attribute value “B company” from the user or the like as a display condition in the attribute information display area 83 of FIG. 8.

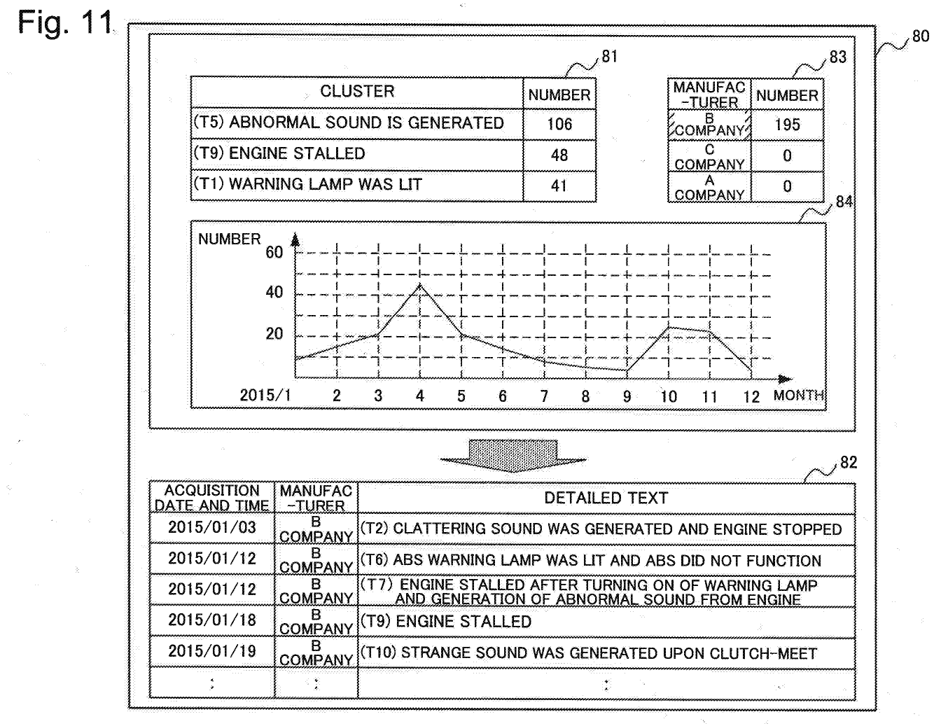

FIG. 11 is a diagram illustrating an example of the clustering screen 80 (upon designating an attribute value) in the first example embodiment of the present invention.

The element text display unit 52 displays, as in FIG. 11, element texts T2, T6, T7, T9, T10, . . . that are target element texts including the attribute value “B company” in the element text display area 82.

The user or the like refers to the representative text display area 81 of FIG. 11 and thereby can ascertain a failure (“abnormal sound is generated”) having a large number of occurrences with respect to the manufacturer “B company” at an outline level. Further, the user or the like refers to the time-series display area 84 and thereby can ascertain an acquisition period (“2015/3 to 5”, “2015/10 to 12”) having a large number of occurrences of failures with respect to the manufacturer “B company.”

<A Case Where an Attribute Value and an Acquisition Period have been Designated as a Display Condition>

A case where the user or the like confirms details of a failure with respect to an acquisition period “2015/10 to 2015/12” having a large number of occurrences of failures of the manufacturer “B company” in the clustering screen 80 of FIG. 11 will be considered. For example, the reception unit 55 further receives, from the user or the like, a designation of an acquisition period “2015/10 to 2015/12” as a display condition in the time-series display area 84 of the clustering screen 80 of FIG. 11.

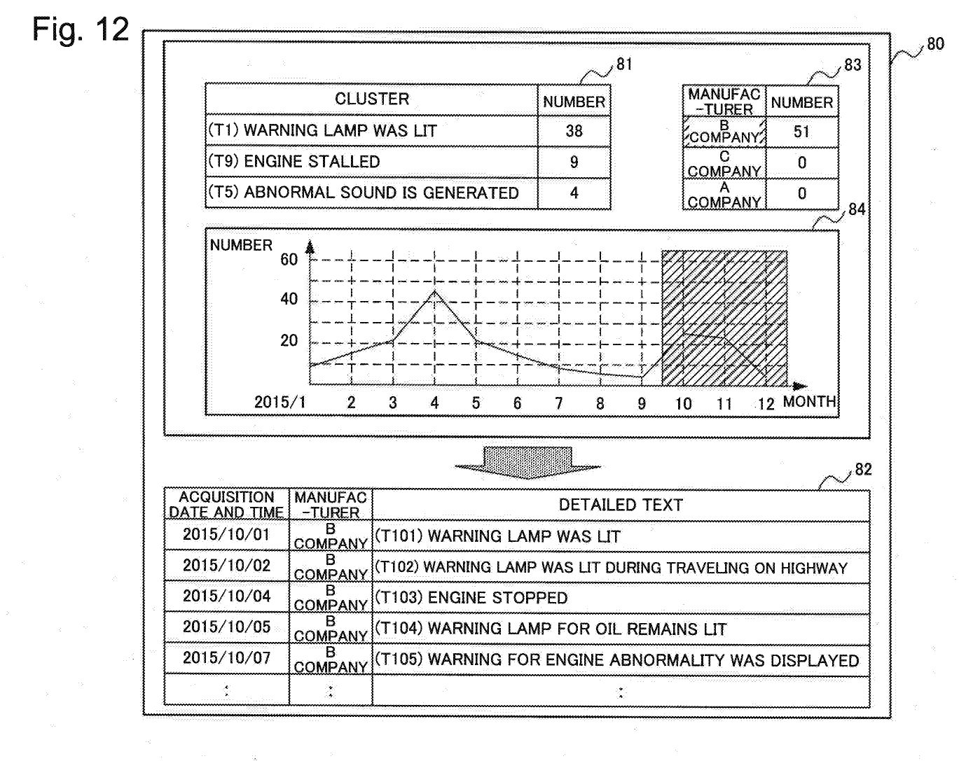

FIG. 12 is a diagram illustrating an example of the clustering screen 80 (upon designating an attribute value and an acquisition period) in the first example embodiment of the present invention.

The element text display unit 52 displays, as in FIG. 12, element texts T101, T102, . . . that include the attribute value “B company” and have an acquisition date and time within the acquisition period “2015/10 to 2015/12” in the element text display area 82.

The user or the like refers to the representative text display area 81 of FIG. 12 and thereby can ascertain a failure (“a warning lamp was lit”) having a large number of occurrences with respect to the acquisition period (“2015/10 to 2015/12”) of the manufacturer “B company” at an outline level.

<A Case Where an Attribute Value, an Acquisition Period, and a Representative Text have been Designated as a Display Condition>

A case where the user or the like confirms details for a failure “a warning lamp was lit” of an outline level having the largest number of occurrences in the acquisition period (“2015/10 to 2015/12”) of the manufacturer “B company” in the clustering screen 80 of FIG. 12 will be considered. For example, the reception unit 55 further receives, from the user or the like, a designation of a representative text T1 “a warning lamp was lit” as a display condition in the representative text display area 81 of FIG. 12.

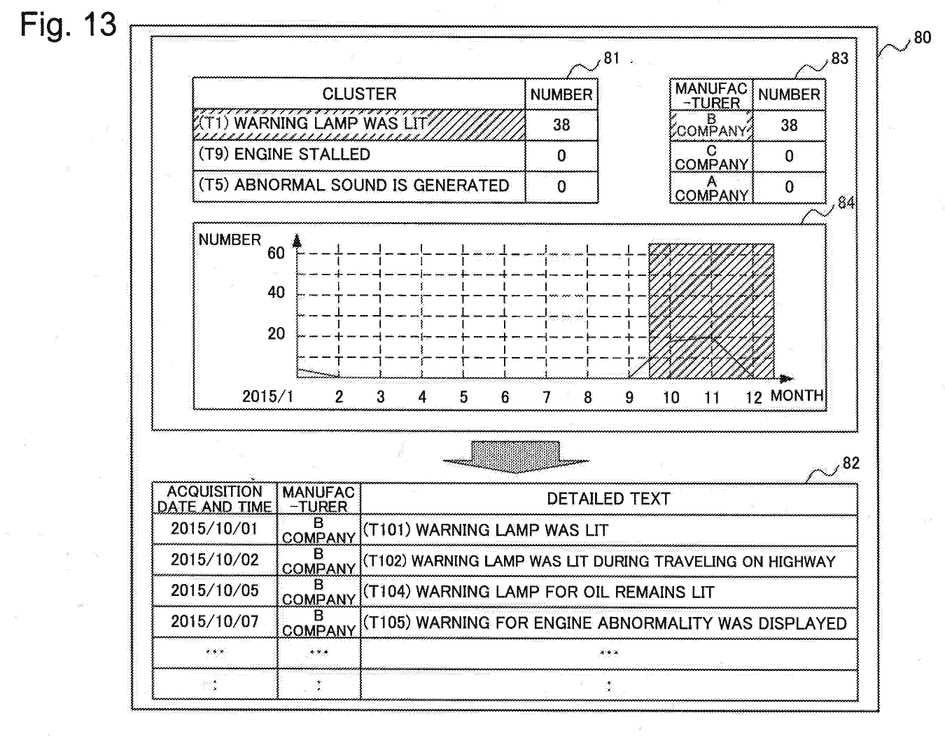

FIG. 13 is a diagram illustrating an example of the clustering screen 80 (upon designating an attribute value, an acquisition period, and a representative text) in the first example embodiment of the present invention.

The element text display unit 52 displays, as in FIG. 13, element texts that are target element texts entailing the representative text T1, including the attribute value “B company”, and having an acquisition date and time within the acquisition period “2015/10 to 2015/12” in the element text display area 82.

The user or the like refers to the element text display area 82 of FIG. 13 and thereby can ascertain details of the failure (“a warning lamp was lit”) of an outline level with respect to the acquisition period (“2015/10 to 2015/12”) of the manufacturer “B company.”

In the above examples, cases where display conditions are “a representative text”, “a plurality of representative texts”, “an attribute value”, “an attribute value and an acquisition period”, and “an attribute value, an acquisition period, and a representative text” have been described. However, without limitation thereto, as a display condition, any combination of one or more of “a representative text”, “an attribute value”, and “an acquisition period” may be designated.

As described above, the operation of the first example embodiment of the present invention is completed.

In the first example embodiment of the present invention, a case where texts to be clustered are texts relating to failure reports of automobiles has been described as an example. However, without limitation thereto, texts to be clustered may be texts relating to any contents such as various phenomena, causes, measures, opinions, evaluations, complaints, demands, and the like.

Further, in the first example embodiment of the present invention, the element text display unit 52 displays, in the element text display area 82, all the texts to be clustered as target element texts in a stage where a display condition is not designated. Without limitation thereto, the element text display unit 52 may omit display of target element texts in a stage where a display condition is not designated.

Further, in the first example embodiment of the present invention, the element text display unit 52 displays, as a display method for an extracted target element text, only an extracted target element text in the element text display area 82. Without limitation thereto, the element text display unit 52 may highlight an extracted target element text while displaying all the texts or specific texts to be clustered.

Further, in the first example embodiment of the present invention, a case where each text to be clustered is provided with an acquisition date and time as a date and time relating to the text has been described as an example. However, without limitation thereto, each text may be provided with an occurrence date and time of a content of the text or an incoming-call date and time upon notification of a content of the text by phone or the like, instead of an acquisition date and time.

Further, in the first example embodiment of the present invention, cases where combinations of “a representative text”, “an attribute value”, and “an acquisition period” are designated as display conditions have been described as examples. However, without limitation thereto, a display condition may further include any keyword relating to a text. In this case, the reception unit 55 receives a designation of a keyword from the user or the like as a display condition in the clustering screen 80. The element text display unit 52 displays an element text including the designated keyword as a target element text in the element text display area 82.

For example, it is assumed that, the reception unit 55 has received a designation of a keyword “engine” as a display condition in the clustering screen 80 of FIG. 8. In this case, the element text display unit 52 displays element texts T2, T4, T7, . . . that are target element texts including the keyword “engine” in the element text display area 82.

Next, a basic configuration of the first example embodiment of the present invention will be described.

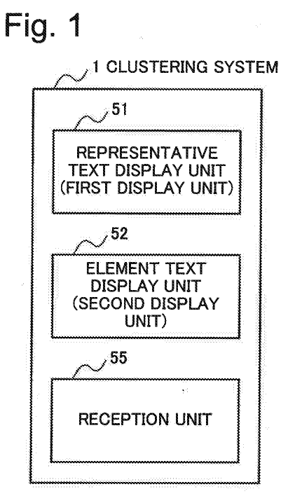

FIG. 1 is a block diagram illustrating a basic configuration of the first example embodiment of the present invention. Referring to FIG. 1, a clustering system 1 (text visualization system) in the first example embodiment of the present invention includes a representative text display unit 51 (first display unit), a reception unit 55, and an element text display unit 52 (a second display unit). The clustering system 1 is accessibly connected to a storage that stores a plurality of texts and information indicating a representative text and an element text that entails the representative text among the plurality of texts. The representative text display unit 51 displays a plurality of representative texts. The reception unit 55 receives a designation of a specific representative text among the plurality of representative texts. The element text display unit 52 extracts, in response to receiving the designation of the specific representative text, an element text that entails the designated specific representative text from the plurality of texts, and displays the extracted element text.

Next, advantageous effects of the first example embodiment of the present invention will be described.

In the above-described keyword-based clustering, a viewpoint of each cluster becomes unclear, and therefore a work of the user for clarifying a viewpoint is needed. For example, even when clustering simply based on a keyword or clustering based on dependency between keywords is performed for the above-described text data of FIG. 5, the texts T9, T2, and T4 are respectively classified into different clusters. In this case, texts having the same viewpoint are classified into a plurality of clusters, and therefore it is necessary to confirm the texts in the clusters.

According to the first example embodiment of the present invention, a user can efficiently ascertain a result of clustering of texts. The reason is that the representative text display unit 51 displays a plurality of representative texts and the element text display unit 52 extracts, in response to reception of a designation of a specific representative text, element texts that entail the designated specific representative text and displays the extracted element texts.

Thereby, the user can first ascertain a viewpoint at an outline level by a representative text and then can ascertain, by designating a representative text of a specific viewpoint, details of each text classified into a cluster of the viewpoint. In other words, the user can analyze a clustering result by a drill-down technique as in a manner from an outline to details.

A cluster is generated for each viewpoint, and therefore it is unnecessary for the user to confirm texts of a plurality of clusters to clarify a viewpoint and reclassify the texts as in the case of the above-described keyword-based clustering. For example, in the first example embodiment of the present invention, the above-described texts T2 and T4 are classified into the same cluster as element texts of the text T9.

Further, in the above-described keyword-based clustering, a keyword relating to a cluster is merely presented, and therefore it has been difficult to understand a content of the cluster.

According to the first example embodiment of the present invention, a clustering result can be presented in such a way as to be easily understood by a person. The reason is that the representative text display unit 51 displays a text written using a natural sentence as a representative text of each cluster.

Further, in the above-described keyword-based clustering, a viewpoint of each cluster becomes unclear, and therefore it has been difficult to extract a text including a plurality of viewpoints even upon designating a plurality of clusters.

According to the first example embodiment of the present invention, in clustering of texts, a user can efficiently ascertain a text relating to a plurality of viewpoints. The reason is that the element text display unit 52 extracts, in response to reception of a designation of a plurality of specific representative texts, an element text that entails all of the designated plurality of specific representative texts and displays the extracted element text.

A cluster is generated for each viewpoint, and therefore a text relating to a plurality of viewpoints can be extracted by designating a plurality of clusters.

Further, in clustering of texts, even when clustering of texts of a specific attribute value or a specific acquisition date and time is performed, a cluster local for the attribute value or the acquisition date and time has been generated in some cases.

According to the first example embodiment of the present invention, in clustering of texts, texts including various attribute values or acquisition dates and times can be analyzed using exhaustive clusters. The reason is that the display control unit 50 displays the number of element texts for each attribute value and each acquisition date and time, and extracts element texts suitable for a condition of an attribute value and an acquisition date and time, with respect to a result of entailment clustering obtained for all the texts to be clustered. Thereby, using a common viewpoint among different attribute values and acquisition dates and times, results of clustering can be compared.

### Second Example Embodiment

Next, a second example embodiment of the present invention will be described.

The second example embodiment of the present invention is different from the first example embodiment of the present invention in a point that a display control unit 50 displays an analysis table 91.

First, a configuration of the second example embodiment of the present invention will be described.

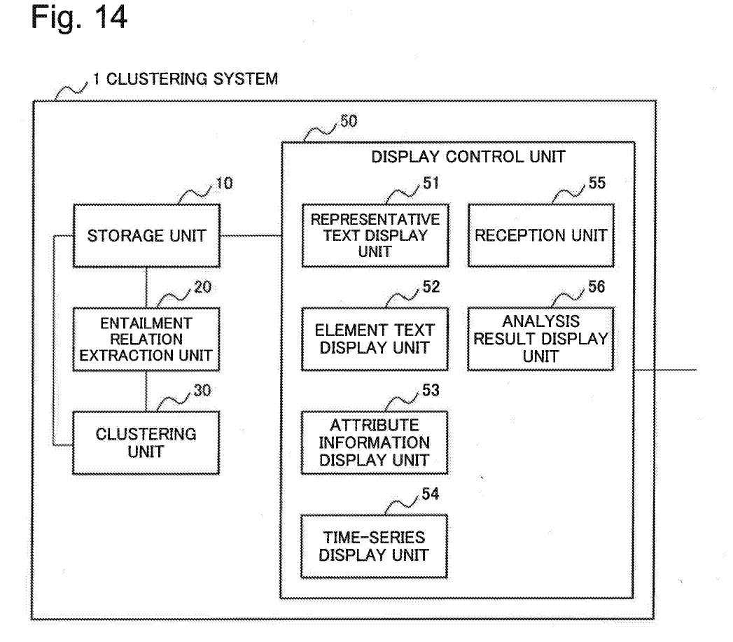

FIG. 14 is a block diagram illustrating a configuration of a clustering system 1 in the second example embodiment of the present invention.

Referring to FIG. 14, the clustering system 1 in the second example embodiment of the present invention further includes, in the display control unit 50, an analysis result display unit 56 (or a fifth display unit), in addition to the configuration of the clustering system 1 in the first example embodiment of the present invention.

The analysis result display unit 56 generates an analysis table 91 that represents a relationship (correlation) between a representative text entailed by an element text (a cluster to which the element text belongs) and an attribute value included in the element text, and displays the generated analysis table 91.

Next, the operation of the second example embodiment of the present invention will be described.

In step S105 described above, the reception unit 55 of the display control unit 50 receives an instruction for generation of an analysis table 91 in the clustering screen 80.

The analysis result display unit 56 tallies the number of element texts for each set of a representative text and an attribute value based on a clustering result. The analysis result display unit 56 generates a spreadsheet representing the tally result as the analysis table 91.

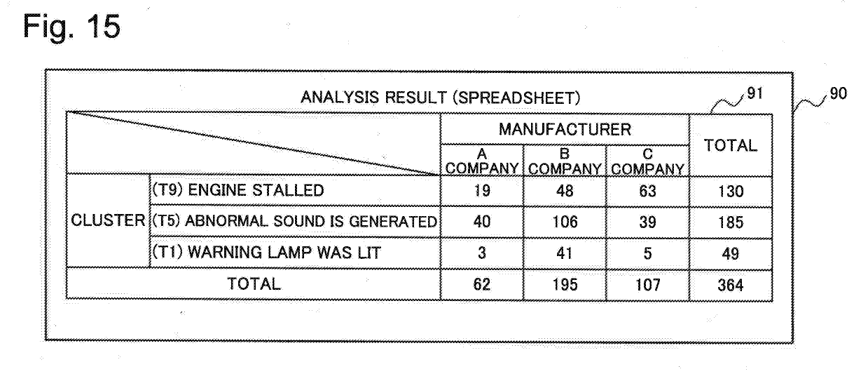

FIG. 15 is a diagram illustrating an example of an analysis screen 90 (upon displaying a spreadsheet) in the second example embodiment of the present invention. The analysis screen 90 includes the analysis table 91 (a spreadsheet). In the example of FIG. 15, in the analysis table 91 (a spreadsheet), with respect to a set of each of representative texts T9, T5, and T1 and each of attribute values “A company,” “B company,” and “C company,” the number of element texts that entail the representative text and include the attribute value is displayed.

For example, the analysis result display unit 56 generates an analysis table 91 as in FIG. 15 based on the clustering result of FIG. 7 and displays the generated table on the analysis screen 90.

Further, the analysis result display unit 56 may further generate a table in which adjusted standardized residuals are calculated for the above-described spreadsheet, as the analysis table 91.

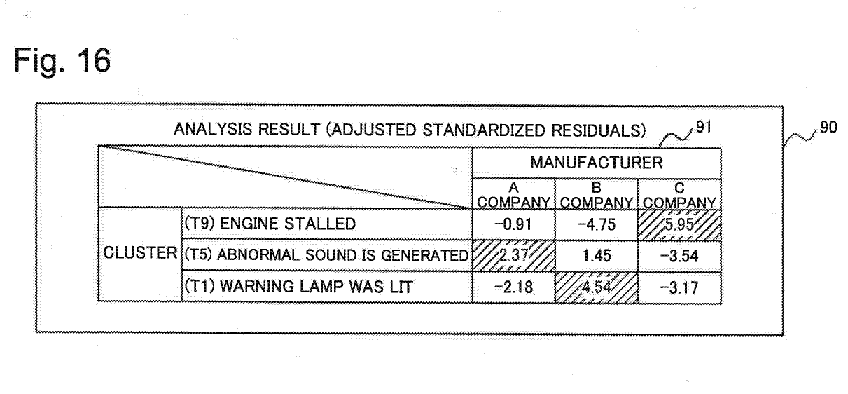

FIG. 16 is a diagram illustrating an example of the analysis screen 90 (upon displaying adjusted standardized residuals) in the second example embodiment of the present invention. In the adjusted standardized residual table, for each cell of the spreadsheet, a residual between an expected value calculated assuming that a representative text and an attribute value are independent and an actual value is calculated. When the residual is large, it is determined that these are not independent, i.e. a correlation is high. For example, when a value of an adjusted standardized residual is equal to or more than +2/equal to or less than −2, a value of each cell of the spreadsheet is determined as being significantly large/small at a level of 5%.

In the example of FIG. 16, in the analysis table 91 (an adjusted standardized residual table), for a set of each of the representative texts T9, T5, and T1 and each of the attribute values “A company,” “B company,” and “C company,” an adjusted standardized residual is displayed. Then, a cell in which a value of an adjusted standardized residual is equal to or more than +2 is highlighted.

For example, the analysis result display unit 56 generates an analysis table 91(an adjusted standardized residual table) as in FIG. 16 based on the spreadsheet of FIG. 15 and displays the generated table on the analysis screen 90.

The user or the like refers to the analysis table 91 of FIG. 16 and thereby can ascertain a set of a failure of an outline level and an attribute value having a large number of occurrences (“A company” is large in “abnormal sound is generated,” “B company” is large in “a warning lamp was lit,” and “C company” is large in “the engine stalled”).

The analysis result display unit 56 may generate a table representing a relationship calculated by another method as the analysis table 91, as long as a relationship between each representative text and each attribute value can be calculated. For example, the analysis result display unit 56 may generate a table in which, instead of an adjusted standardized residual, a standardized residual or simply a residual is calculated for each cell of a spreadsheet. Further, the analysis result display unit 56 may indicate a relationship between each representative text and each attribute value by using a chi-square value or a log-likelihood ratio.

Next, advantageous effects of the second example embodiment of the present invention will be described.

According to the second example embodiment of the present invention, in clustering of texts, a user can ascertain a relationship between a viewpoint and an attribute value. The reason is that the analysis result display unit 56 generates an analysis table 91 representing a relationship between a representative text entailed by an element text and an attribute value included in the element text, and displays the generated table.

While the invention has been particularly described with reference to exemplary embodiments thereof, the invention is not limited to these embodiments. It will be understood by those of ordinary skill in the art that various changes in form and details may be made therein without departing from the scope of the present invention as defined by the claims.

Hereinafter, an example of a reference embodiment will be supplementarily noted.

(Supplementary Note 1)

A text visualization system including: an information source in which clustering is executed by extracting an entailment relation between texts and classifying texts having an entailment relation into an identical group; first presentation means for presenting a plurality of representative texts selected from the information source as a representative of a cluster among the texts having the entailment relation and receiving a selection; and second presentation means for extracting, in response to the selection of the representative texts, an element text that entails the representative texts from the information source and displaying the extracted element text.

### INDUSTRIAL APPLICABILITY

The present invention is applicable to a system for clustering a large amount of document data. For example, the present invention is applicable to a system that analyzes a call log, opinions of customers, and the like for improvements of products and services, marketing, and improvements of efficiency of business activities. Further, the present invention is also applicable to a system that analyzes failures of products, evaluations for products, and demands for products, or a system that analyzes academic documents. Further, the present invention is also applicable to a system that analyzes questions about customer supports and generates FAQ (Frequency Asked Questions).

### REFERENCE SIGNS LIST

1 Clustering system

2 CPU

3 Storage device

4 Communication device

5 Input device

6 Output device

10 Storage unit

20 Entailment relation extraction unit

30 Clustering unit

50 Display control unit

51 Representative text display unit

52 Element text display unit

53 Attribute information display unit

54 Time-series display unit

55 Reception unit

56 Analysis result display unit

80 Clustering screen

81 Representative text display area

82 Element text display area

83 Attribute information display area

84 Time-series display area

90 Analysis screen

91 Analysis table

1. A text visualization system accessibly connected to storage means that stores a plurality of texts and information indicating a representative text and an element text that entails the representative text among the plurality of texts, the text visualization system comprising:
a memory storing instructions; and
one or more processors configured to execute the instructions to:
display a plurality of representative texts;
receive a designation of a specific representative text among the plurality of representative texts; and
extract, in response to receiving the designation of the specific representative text, an element text that entails the designated specific representative text from the plurality of texts, and display the extracted element text, wherein
a relation between a representative text and an element text that entails the representative text is a relation that the representative text is true when the element text is true.

2. The text visualization system according to claim 1, wherein
a designation of a plurality of specific representative texts among the plurality of representative texts is received, and
in response to receiving the designation of the plurality of specific representative texts, an element text that entails all the designated plurality of specific representative texts is extracted from the plurality of texts, and the extracted element text is displayed.

3. The text visualization system according to claim 1, wherein
the storage means further stores an attribute value of each of the plurality of texts,
a designation of a specific attribute value is further received, and
in response to receiving the designation of the specific attribute value, an element text including the designated specific attribute value is extracted from the plurality of texts, and the extracted element text is displayed.

4. The text visualization system according to claim 1, wherein
the storage means further stores a date and time relating to each of the plurality of texts,
a designation of a specific period is further received, and
in response to receiving the designation of the specific period, an element text relating to a date and time within the designated specific period is extracted from the plurality of texts, and the extracted element text is displayed.

5. The text visualization system according to claim 1, wherein
a designation of a specific keyword is further received, and
in response to receiving the designation of the specific keyword, an element text including the designated specific keyword is extracted from the plurality of texts, and the extracted element text is displayed.

6. The text visualization system according to claim 1, wherein
the storage means further stores an attribute value of each of the plurality of texts, and
the one or more processors configured to further execute the instructions to display, for each attribute value, a number of element texts displayed.

7. The text visualization system according to claim 1, wherein
the storage means further stores a date and time relating to each of the plurality of texts, and
the one or more processors configured to further execute the instructions to display, for each date and time, a number of element texts displayed.

8. The text visualization system according to claim 1, wherein
the storage means further stores an attribute value of each of the plurality of texts, and
the one or more processors configured to further execute the instructions to display a table representing a relationship between a representative text entailed by an element text and an attribute value included in the element text.

9. A text visualization method for a plurality of texts among which a representative text and an element text that entails the representative text are set, the text visualization method comprising:
displaying a plurality of representative texts;
receiving a designation of a specific representative text among the plurality of representative texts; and
extracting, in response to receiving the designation of the specific representative text, an element text that entails the designated specific representative text from the plurality of texts, and displaying the extracted element text, wherein
a relation between a representative text and an element text that entails the representative text is a relation that the representative text is true when the element text is true.

10. A non-transitory computer readable storage medium recording thereon a program causing a computer to perform a text visualization method for a plurality of texts among which a representative text and an element text that entails the representative text are set, the method comprising:
displaying a plurality of representative texts;
receiving a designation of a specific representative text among the plurality of representative texts; and
extracting, in response to receiving the designation of the specific representative text, an element text that entails the designated specific representative text from the plurality of texts, and displaying the extracted element text, wherein
a relation between a representative text and an element text that entails the representative text is a relation that the representative text is true when the element text is true.
